(19) United States
(12) Patent Application Publication
(10) Pub. No.: US 2026/0127460 A1
(43) Pub. Date: May 7, 2026

(54) Domain Specific Agents for an AI Agentic Architecture

(71) Applicant: Aisera, Inc., Palo Alto, CA (US)

(72) Inventor: Antonio Nucci, San Jose, CA (US)

(21) Appl. No.: 19/375,874

(22) Filed: Oct. 31, 2025

Related U.S. Application Data
(60) Provisional application No. 63/715,091, filed on Nov. 1, 2024.

(51) Int. Cl. G06N 5/04; G06N 5/02

(52) U.S. Cl. CPC G06N 5/04; G06N 5/02

(57) ABSTRACT

A method of selecting and interacting with agent types for an agentic AI system includes deploying an agent based on a template, with the agent assigned to a functional domain required by an enterprise, wherein the agent is selected to be one of a Prescriptive Conversational Agent; a Prescriptive Action Agent; a Q&A Retrieval Agent for private knowledge bases; a Q&A Retrieval Agent for public knowledge bases; a Dynamic Multi-task Action Agent; and a Personal Assistant Agent. The selected agents can be connected to a reasoning engine and orchestration module able to send and receive requests to the agent.

### RELATED APPLICATION

The present disclosure is part of a non-provisional patent application claiming the priority benefit of U.S. Patent Application No. 63/715,091, filed on Nov. 1, 2024, which is hereby incorporated by reference in its entirety.

### TECHNICAL FIELD

The present disclosure generally relates to use of systems and processes in an enterprise support system that allow for dynamically selecting and utilizing multiple software agents of differing capability. In some embodiments, the agents are associated with various functional domains to improve decision making.

### BACKGROUND

Agent based software systems that support and act on behalf of an enterprise have been used to enhance operational efficiency, improve decision-making, and allow for personalized user interactions. Unfortunately, many such systems rely on fixed workflows and predefined rules and experiences and have proven inadequate in addressing the dynamic needs of modern enterprises.

What is needed are development and deployment of autonomous agents capable of dynamic learning, decision-making, and interaction within complex environments. Such systems can optimize workflows, reduce operational costs, and respond more effectively to changing business needs. This adaptability can drive higher productivity but enables organizations to stay competitive in an increasingly dynamic marketplace.

### SUMMARY

In some embodiments, a method of selecting and interacting with agent types for an agentic AI system includes deploying an agent based on a template, with the agent assigned to a functional domain required by an enterprise, wherein the agent is selected to be one of a Prescriptive Conversational Agent; a Prescriptive Action Agent; a Q&A Retrieval Agent for private knowledge bases; a Q&A Retrieval Agent for public knowledge bases; a Dynamic Multi-task Action Agent; and a Personal Assistant Agent. The selected agents can be connected to a reasoning engine and orchestration module able to send and receive requests to the agent.

In one embodiment, a method of operating an agentic AI system able to respond to a user request includes the steps selecting a set of multiple agents, each agent being assigned to a functional domain required by an enterprise, wherein the agent is selected to be one of a Prescriptive Conversational Agent; a Prescriptive Action Agent; a Q&A Retrieval Agent for private knowledge bases; a Q&A Retrieval Agent for public knowledge bases; a Dynamic Multi-task Action Agent; and a Personal Assistant Agent. A reasoning engine supported by at least one large language model (LLM) is provided, with the reasoning engine acting to interpret a user request and decompose the user request into one or more mini-tasks. An orchestrator module connected to the reasoning engine provides for routing of mini-tasks based on the user request to at least one of the multiple agents for further processing. The orchestrator module and reasoning engine can collect and reconcile processed results from the multiple agents and prepare a response to the user request. In some embodiments, the agents can be dynamically added or removed from the set of multiple agents.

### BRIEF DESCRIPTION OF THE DRAWINGS

FIG. 1 depicts an agentic AI system architecture able to respond to user requests in accordance with an embodiment.

FIG. 2 depicts a method of operating an agentic AI system in accordance with an embodiment.

FIG. 3 depicts the associate flow template for select branches of a Prescriptive Conversational Agent.

FIG. 4 depicts an example of a prescriptive answer entered by the user for a Mental Wellness agent.

FIG. 5 depicts a flow template for a Prescriptive Action Agent.

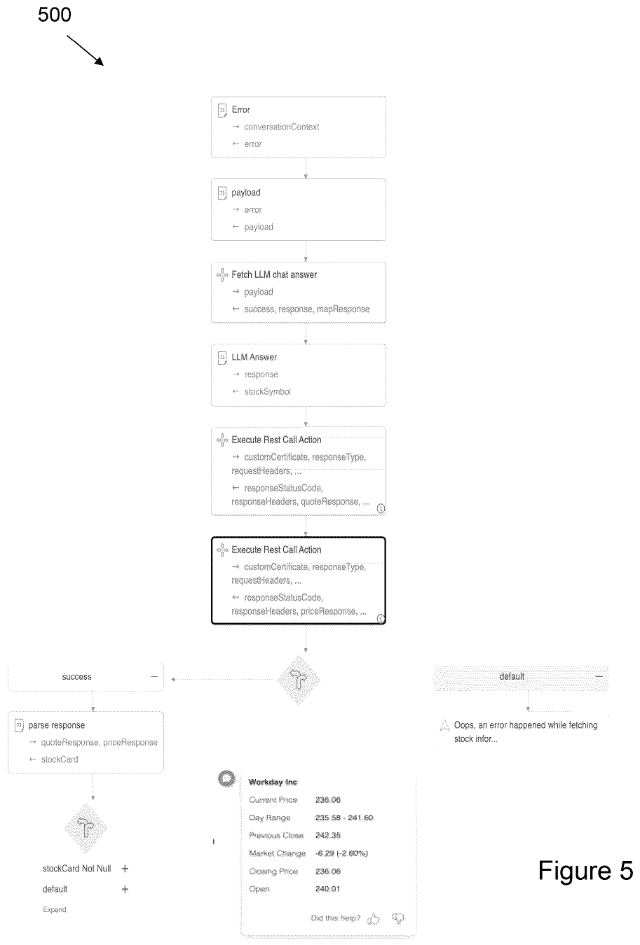

FIG. 6 depicts a computer system capable of supporting or acting as a component of the agentic AI system in accordance with an embodiment.

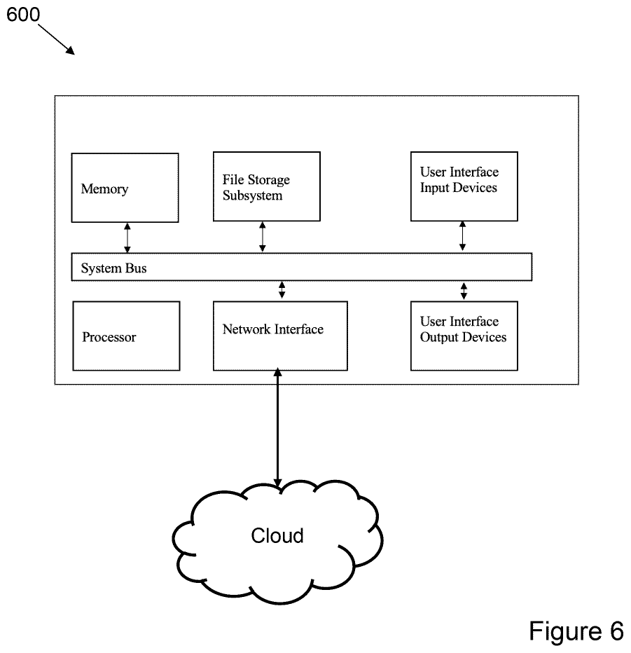

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION OF THE DRAWINGS

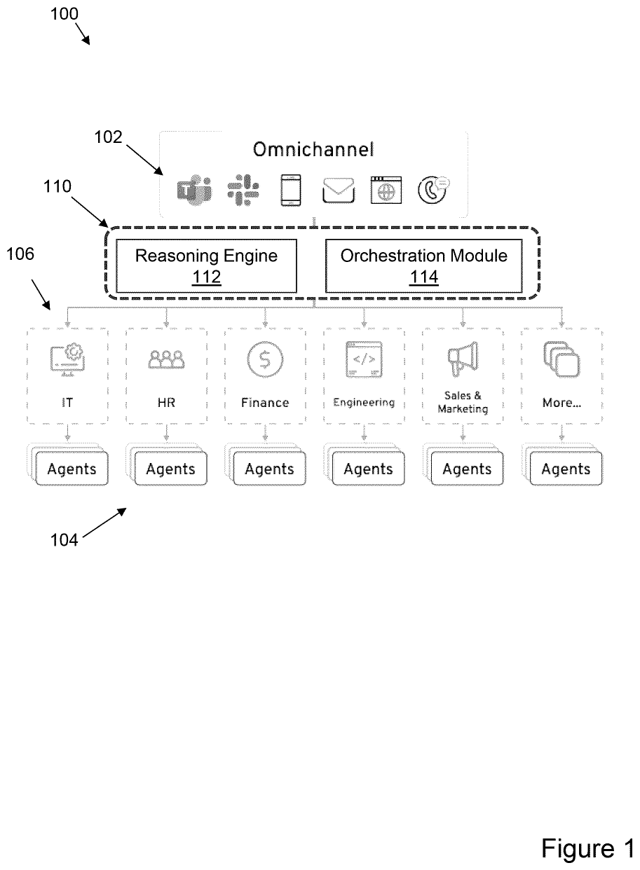

FIG. 1 depicts an agentic AI system architecture 100 able to respond to user requests made through a communication omnichannel 102 in accordance with an embodiment for the purposes of the present technology. The system architecture 100 includes a set of multiple agents 104, each agent being assigned to various specific functional domains 106 required by an enterprise. In some embodiments, agents can be dynamically added or removed from the set of multiple agents. In some embodiments, the agents 104 can be external agents that can operate on distinct and separate enterprises with other system architectures and not be directly controlled by agentic AI system architecture 100. Interaction with agents 104 is provided by an AI system 110 that includes a reasoning engine 112 supported by at least one large language model (LLM), with the reasoning engine 112 being able to interpret a user request and decompose the user request into one or more mini-tasks. In some embodiments, the reasoning engine 112 can engage the user for clarification in response to the user request. This is of particular importance in scenarios where the user request is vague or ambiguous, and the reasoning engine needs to proactively engage the user for clarification. This step ensures that the reasoning engine 112 attains a clear and precise understanding of the request before moving forward.

The AI system 110 also includes an orchestrator/orchestration module 114 connected to the reasoning engine 112 that is able to route those mini-tasks based on an understood user request to at least one of the multiple agents for further processing. During operation, the orchestrator module 114 and reasoning engine can collect and reconcile processed results from the multiple agents and prepare a response to the user request delivered the communication omnichannel 102.

In some embodiments, the communication omnichannel 102 allows for receipt of a user request submitted through an engagement channel to the agentic AI system 100. The omnichannel 102 can include a wide range of communication platforms and modes of supporting user requests. For example, email, chat, telephone messages, chatbots, social media comments, or internal enterprise communication channels can all be used to provide user requests. In some embodiments, user requests can be associated with specific persons, while in other embodiments user requests can be associated with organizations, enterprise groups, or even totally or semi-automated AI or rules based services. In some embodiments, the engagement channel of omnichannel 102 can help select and prioritize user requests. For example, handling a user request can be based on time priority, organizational importance, emergency status, or user status. In other embodiments, user requests can be translated, edited, or otherwise modified by the engagement channel to better present the user request to the AI system 110 with included reasoning engine 112 and agents 104.

In some embodiments both the reasoning engine 112 and agents 104 can incorporate or have access to AI systems. Such AI systems can be based on machine learning models including those having reinforcement learning (RL), supervised learning models, unsupervised learning models, semi-supervised learning models, deep learning models, neural networks, simulated annealing models, ensemble models, and large language models (LLM).

Various algorithms, techniques, and specific models usable in AI systems include but are not limited to GPT variants (e.g. Generative Pre-trained Transformer (GPT), GPT-2, GPT-3, GPT-4, DistillGPT2, OpenAI-GPT, or EleutherAI/gpt-j-6b) as well as models such as Large Language Model Meta AI (LLaMA), BERT, XLNet, or RoBERTa.

In some embodiments use of reinforcement learning via either the reasoning engine 112 or the agents 104 has particular advantages. Agentic AI systems utilize reinforcement learning (RL) to continuously enhance their performance through iterative learning and adaptation. Unlike traditional AI, which relies mostly on human-driven supervised learning, RL-based systems dynamically evolve by interacting with their environment and receiving feedback from these interactions. This adaptive learning process enables them to optimize their responses and decision-making capabilities over time, leading to more effective and efficient user interactions.

In reasoning engines, reinforcement learning significantly enhances AI by improving its grasp of key entities, abbreviations, synonyms, and context. RL enables the AI to continuously adapt to diverse user expressions and recognize varying terminology within specific domains. It helps the system interpret user queries more accurately and handle ambiguity more effectively by learning from past interactions. This ongoing adaptation allows the AI to clarify uncertainties quickly, streamline conversations, and deliver more precise, context-aware responses, ultimately optimizing user experience.

In some embodiments, the agentic AI system architecture 100 and included subsystems such as the reasoning engine 112, orchestration module 114, and agents 104 can be operated using a digital processor and data storage system. As used herein, a processor and a processor architecture are related concepts but refer to different aspects of computer systems. Specifically, a processor, such as a CPU or a GPU, performs calculations under the control of program instructions. The processor performs tasks such as arithmetic operations, logical operations, and data movement. ‘Processor architecture’, also referred to as computer architecture, encompasses the design and organization of a processor. It defines the structure, behavior, and functionality of the processor, including its instruction set, registers, memory organization, data paths, control units, and other internal components. Processor architecture provides the foundation that determines how the processor executes instructions, handles data, and interacts with other system components. Processor architecture influences factors like instruction set design, performance characteristics, power consumption, and compatibility with software. Multiple processors can share the same architecture, allowing for compatibility across different processor implementations. In some embodiments, processor architectures can include deterministic processor architectures or non-deterministic processor architectures. In some embodiment, processor architectures can include reduced instruction set computers (RISC) processors, complex instruction set computers (CISC) processors, application specific integrated circuits (ASIC) or field programmable gate-array (FPGA) configured to execute a certain instruction set architecture, as well as tensor streaming processors (TSP).

Typically, multiple intercommunicating processors are used to support the agentic AI system architecture 100. Embodiments of multi-chip systems can be implemented in a variety of topologies for flexible packaging and deployment in rack-scale, cluster scale, or cloud based systems. Communication occurs in a pair-wise manner between a sender port and a receiver port or can alternatively include broadcast communications.

In some embodiments, the reasoning engine 112 and agents 104 can operate using functional domains 106 as constraints that can simplify and improve reasoning tasks. Functional domains 106 can include but are not limited to Information Technology (IT), Human Resources (HR), Finance, Engineering, and Sales and Marketing. Both response to user requests by the reasoning engine and agent operation can benefit by logical structuring using functional domains. The reasoning engine 112 needs to accurately interpret and process user requests. By leveraging domain-specific Large Language Models (LLMs), the reasoning engine 112 can maximize its understanding of each request and minimize unnecessary or irrelevant interactions with users. Domain-specific LLMs allow tailoring to comprehend the unique terminology, jargon, and contextual nuances of specific fields, resulting in a more precise and relevant interpretation of user intents. Similarly, use of domain-specific LLMs in deployed specialized agents can be finely tuned to the specific needs and nuances of each department. By grouping agents according to their functional domain, organizations can streamline workflows, enhance task accuracy, and ensure that each agent operates within the context it understands best.

This domain-specific organization can act as a backbone for scalable and modular deployment of agentic AI systems. Enterprises can begin their adoption with specific domains, like deploying initial AI agents for HR to manage PTO requests and onboarding processes, and then gradually expand to other areas such as IT for user provisioning and troubleshooting, or Engineering for project management automation. As these AI agents become increasingly integrated into various workflows, the system can scale organically to encompass more functionalities and departments. This modular approach not only simplifies the implementation process but also makes it easier to manage and maintain the AI ecosystem as it grows.

The ability to compartmentalize and focus on functional domains also enhances the system's adaptability. As new business requirements emerge or as the organization scales, additional agents can be introduced and integrated seamlessly into the existing framework. This flexibility ensures that the agentic AI architecture evolves alongside the enterprise, consistently meeting its changing needs without necessitating a complete overhaul of existing systems. This logical, domain-oriented organization assists enterprises looking to achieve long-term success and high ROI from their investment in agentic AI solutions.

In some embodiments, hundreds, thousands, or more agents can be used to enable enterprise support using the AI system 110, with its reasoning engine 112 and orchestration module 114. Agents 104 can be designed to handle distinct tasks and are orchestrated by a one or more reasoning engines. In some embodiments, a single central reasoning engine can be used to ensure cohesive operation and orchestration across the system.

The agents in agentic AI can be categorized into five types: Generative Information Retrieval Agents (agents for knowledge serving for less-regulated environments/topics), Prescriptive Knowledge Agents (agents for knowledge serving for highly-regulated environments/topics), Dynamic Workflow Agents (Action Agents), and User Assistant Agents.

Generative Information Retrieval Agents are of particular use to enterprises when handling less-regulated environments or topics that need quick, accurate, and context-rich answers to user queries. These agents utilize advanced technologies such as Retrieval-Augmented Generation (RAG) to pull data from a wide range of enterprise sources, generating comprehensive responses that adapt to the nuances of each question. This capability is invaluable for addressing diverse and evolving queries, thus improving user experience and operational efficiency. In some embodiments, Generative Information Retrieval Agents can leverage reinforcement learning to enhance their knowledge delivery. These agents continuously update their knowledge bases and refine their ability to generate accurate and relevant answers through user interactions. As they accumulate experience from processing queries and feedback, they improve their contextual understanding and become more adept at providing precise responses. They also utilize historical data to handle similar inquiries with greater accuracy.

In the realm of IT troubleshooting, Generative Information Retrieval Agents can quickly diagnose and resolve technical issues by accessing internal databases, past support tickets, and user manuals. For example, if an employee reports connectivity problems, the agent can instantly search through logs, past incidents, and troubleshooting guides to pinpoint the issue and suggest steps for resolution. For example, these agents can provide step-by-step instructions for installing or updating software by referencing internal IT documentation and user manuals, ensuring the process is clear and error-free.

In HR settings, these agents are adept at managing a variety of employee queries regarding policies, benefits, and organizational procedures. For instance, if an employee inquiry about the company's remote work policy, the agent can retrieve the latest guidelines and ensure the response is up-to-date and accurate. For example, the agent can provide a list of public holidays, including any specific company holidays, ensuring employees have the correct and most recent information.

Generative Information Retrieval Agents can also significantly benefit Engineering teams by quickly accessing project documentation, past project experiences, and technical resources. For example, when an engineer faces a specific coding issue, the agent can pull relevant code snippets, troubleshooting steps, and solutions from past projects or documentation, thereby speeding up problem-solving. For example, an engineer needing details about project milestones or specifications can query the agent, which can then provide the necessary information from the company's project management tools or internal wikis.

Prescriptive Knowledge Agents excel in providing adaptive and context-rich responses by dynamically synthesizing information from various sources, there are environments where consistency, compliance, and predictability are paramount. In such cases, Prescriptive Knowledge Agents come into play. These agents deliver deterministic answers based on predefined workflows and curated datasets, ensuring that responses are both accurate and reliable. Unlike their generative counterparts, prescriptive agents adhere strictly to established guidelines and rules, making them ideal for regulated domains or scenarios where precise and compliant information is critical.

For IT, a Prescriptive Knowledge Agent can provide specific instructions for responding to data breaches, handling sensitive information, and following data compliance protocols such as GDPR or HIPAA.

Similarly, for HR, a Prescriptive Knowledge Agent can offer legally approved responses to sensitive issues such as reporting harassment, addressing mental wellness concerns (like suicidal thoughts), or dealing with racism and gender discrimination. These topics require carefully crafted responses that comply with legal requirements and organizational policies. Providing consistent, pre-approved answers ensures that the information is accurate, legally compliant, and sensitive to the emotional needs of the employees involved.

For Engineering, a Prescriptive Knowledge Agent can provide detailed, predefined instructions for adhering to safety regulations, conducting equipment maintenance, and following operational standards. This includes step-by-step guides for safe machine operation, routine maintenance checklists, and emergency shutdown procedures. In the engineering domain, precise adherence to safety and operational standards is essential to prevent accidents and ensure compliance with industry regulations. Predefined responses ensure that engineers follow established guidelines accurately, minimizing the risk of errors and maintaining a safe work environment. Additionally, compliance with these standards is often legally mandated, making consistent and correct guidance critical.

While Generative Information Retrieval Agents excel at providing adaptive, context-rich answers by synthesizing information from various sources, and Prescriptive Knowledge Agents ensure compliance and reliability through consistent, predefined responses, another realm of AI exists that takes operational efficiency to the next level is known as Dynamic Workflow Agents. These specialized agents perform tasks involving interaction with multiple external applications and systems. They are capable of breaking down requests into specific sequences of API calls, executing these calls, and checking for errors and correctness along the way.

Dynamic Workflow Agents represent a significant advancement in automating complex workflows and enhancing operational efficiency. Unlike traditional workflows, which are often rigid and limited to executing predefined API calls, these agents dynamically discover necessary APIs (discovery), determine the correct sequence of operations (plan), and autonomously execute and verify tasks (execution). This flexibility allows them to handle a wide variety of user requests in real-time, offering a more adaptive and intelligent approach to workflow automation.

Moreover, Dynamic Workflow Agents offer scalability and adaptability that traditional workflows cannot match. As new features are added to an application or as APIs evolve, the agents can automatically adjust their operations without requiring manual reconfiguration. This flexibility is particularly valuable in dynamic environments where business requirements and technological capabilities are constantly changing.

For instance, in a traditional setup within an HR system, managing Paid Time Off (PTO) requests might require multiple workflows. Each workflow would be specialized for different scenarios—approving PTO, updating balances, notifying managers, and adjusting payroll. These workflows are often hardcoded, requiring manual updates whenever business processes or APIs change. In contrast, AI action agents can streamline the entire PTO management process. When an employee submits a PTO request, a trained AI agent can automatically discover all relevant APIs—such as those for checking PTO balances, processing approvals, and updating records. The agent then dynamically determines the correct order in which these APIs should be invoked and executes the entire process autonomously. This not only eliminates the need for multiple manual workflows but also ensures that the process is more reliable and less prone to errors, as the agent continuously verifies each step of the execution.

Similar benefits can be achieved in any other domains like Engineering (e.g., managing tasks in Jira like creating tasks, assigning them, updating status, adding comments), IT (e.g., managing teams, permissions, channels and groups in team support software).

Building on the capabilities of AI Workflow Agents, which streamline and automate intricate tasks across various applications are User Assistant Agents. While Workflow Agents focus on managing system operations and integrations, User Assistant Agents are designed to assist individual users directly with their day-to-day activities, making their work more efficient and productive. User Assistant Agents can perform a wide range of tasks that simplify routine operations. In some embodiments, User Assistant Agents can benefit from reinforcement learning by continuously learning from user interactions. This ongoing process enhances their understanding of the specific user needs and preferences, allowing them to deliver more personalized and effective assistance.

For example, in IT, User Assistant Agents can support employees daily need to schedule meetings with team members, stakeholders, or vendors for project discussions and reviews. The scheduling agent finds mutually available times by accessing calendars, sends out meeting invitations, and sets up virtual or physical meeting spaces. This automates the scheduling process, reduces back-and-forth communications, and ensures efficient meeting planning.

As another example, in HR, User Assistant Agents can support an employee who needs to prepare various documents such as job descriptions, policy updates, and employee handbooks. The document drafting agent can generate initial drafts based on templates and user inputs, which the HR team can then review and finalize. This speeds up the document creation process and ensures consistency across all HR documentation.

As another example, in Engineering, User Assistant Agents can support Engineers regularly need to communicate technical updates, project progress, or bug reports with their team or stakeholders. The email-writing agent drafts clear, concise, and professionally worded emails based on brief user inputs, ensuring technical accuracy and coherence. This saves engineers time and ensures consistent communication standards.

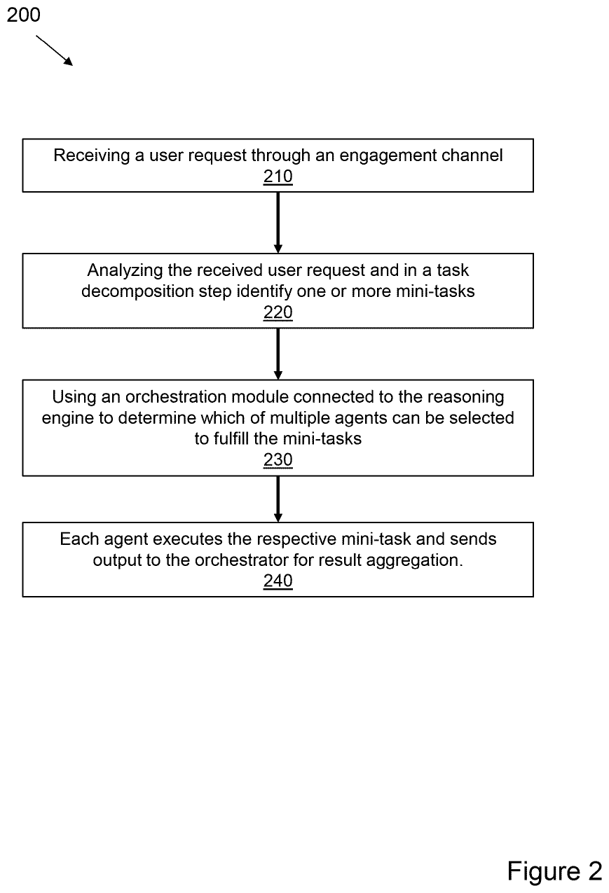

FIG. 2 depicts a flow chart 200 for implementing a method of orchestrating actions in an agentic AI system. In a first step 210, a user request is received through an engagement channel. In a second step 220, a reasoning engine is used to analyze the received user request and in a task decomposition step to identify one or more mini-tasks that require fulfillment. In step 230, an orchestration module connected to the reasoning engine is used to determine which of multiple agents can be selected to fulfill the mini-tasks. Optionally, each agent can be assigned to a functional domain required by an enterprise. In step 240, each agent executes the respective mini-task and sends output to the orchestrator for result aggregation.

In some embodiments, during execution of the flow chart of FIG. 2, the orchestration module can act in an unsupervised mode to discover which of multiple agents are needed to fulfill the user request, plan a sequence of agent invocation, execute the plan, and verify execution correctness.

In some embodiments, during execution of the flow chart of FIG. 2, the orchestration module can act in a supervised mode with mini-tasks and agents used being externally provided.

In some embodiments, during execution of the flow chart of FIG. 2, the orchestration module can act in a semi-supervised mode with mini-tasks being externally provided and the agents used being determined by the agentic AI system.

In some embodiments, during execution of the flow chart of FIG. 2, each agent independently executes the respective mini-task. In other embodiments, agents can interact with other agents to execute the respective mini-task.

In some embodiments, an enterprise can be supported by agents that are sophisticated, autonomous software entities designed to perform specific tasks, facilitate workflows, knowledge retrieval and provide intelligent interactions within an enterprise environment. These agents leverage workflows, generative AI (mostly prompts) and integrations with enterprise backend applications and systems to understand the user request and execute their business logic when invoked by the reasoning and orchestration layer. Each agent is unique and specialized in a specific task. Based on the task the agent is meant to execute, the agent can tap into specific foundational services.

At a high level, at least the following types of agents can be used in an agentic AI system such as disclosed herein:

Prescriptive Conversational Agent: Provides guided interactions via messaging (customized and formatted answer) or conversational flows (e.g., workflows with predefined user interactions leading to customized answers or specific knowledge articles for reference).

Prescriptive Action Agent: Executes structured workflows, like provisioning a software application via Okta, or request PTO, or create a ticket in the service desk, etc.

Q&A Retrieval Agent (Private KB): Queries and retrieves information from enterprise private knowledge bases, providing synthesized responses from proprietary or internal documents.

Q&A Retrieval Agent (Public KB): Queries and retrieves information from trusted public sources, like support pages of Microsoft products and services (support.microsoft,com), etc. or general information on HR terminology and definitions from dol.gov, etc.

Dynamic Multi-task Action Agent: Generates dynamic workflows in real-time (see Hyper-Flow patent) based on the system it integrates with. For example, an agent might be specialized in PTO and Leave Management for Workday HR system, another agent might be specialized in Training Management for workday HR System, another might be specialized in Expense Management for Concur System, another might be specialized for Sales Operations Reporting for SAP System, etc. Those agents are capable of discovering what APIs to call, in what sequence they shall be called and use the provided integrations with the backend system to actually execute the API sequence till the task is completed.

Personal Assistant Agents: These agents are specialized for specific tasks. Examples of such agents are Image Processing Agents for analyzing images provided as an input and answer questions about them; Translation Agents for translating requests from a language into another language. Those agents can take text or voice as an input and provide the corresponding translations; Summarization Agents for condensing documents, emails, conversational logs, meeting transcripts, and alike into concise summaries; and Communication Writer Agents capable of drafting memos, emails, marketing campaigns, job descriptions, and alike based on user-provided input and directions.

Each of the foregoing described agents has an identity that establishes its role, capabilities, and interactions within an enterprise. The identity of an agent encompasses several core attributes that define its function, persona, and scope of tasks it can perform. In some embodiments, identity can include:

Name & Avatar. The name of the agent is a unique identifier that represents its purpose and function. It can be descriptive of the agent's role or capabilities, making it easier for users to recognize and interact with it. Some examples are: IT HelpBot, HR Benefits Assistant, Finance Budget Tracker, Meeting Scheduler Pro, BusinessCommWriter, ImageAnalyzer, etc. User can also add an Agent Avatar or Photo for further personalization.

Persona. The persona of an agent is the way it communicates and interacts with users. This includes the agent's tone, writing style, and personality traits, which are designed to align with the preferences of the user or the business environment.

Writing Style. For example, the agent's writing style can vary from formal and professional (for tasks like legal or financial assistance) to friendly and conversational (for customer support or internal employee interactions). This style should be consistent with the department or function the agent serves. Example: A legal assistant agent might use formal language such as “Please review the attached contract terms,” whereas a customer support agent might say “Let me help you with that right away!”

Tone and Voice. Tone can be authoritative, helpful, casual, or technical, depending on the intended audience. Agents that interact with executive staff may have a more assertive tone, while agents supporting entry-level employees may adopt a more encouraging and guiding approach.

Personality Traits. The agent's personality can be tailored to the enterprise's culture. For example, an agent could be empathetic and patient when dealing with human resources inquiries, or efficient and detail-oriented for technical or IT-related tasks.

Domain. The domain of an agent is the enterprise logical domain (department like IT, HR, etc.) it is asked to be associated with.

As the type of the agent is specified, the user is presented with a specific template (flow) which is associated with the agent type. The template represents a guided set of input, integrations, external services, channels and business logic to be applied. When the user provides specific information as an input, the pre-built agent-type flow gets customized to serve the specific needs of the user. With minimal information provided by the user, a custom agent can be easily generated.

As an example, the scope and template for a Prescriptive Conversational Agent can involve customization of a generic template. A user can customize the generic template for prescriptive conversational agent by defining the specific scope of the agent through simply providing the following information “Act as an expert capable to provide the prescriptive answer I will provide, for any user request which is related to mental wellness inquiries, like report suicidal thoughts, or feeling unsafe/stressed/under pressure/depressed/anxious or experience mood disorders/mood swings at work or office, or willingness to bring at work or office weapons, fire arms, gun, pistol, knife at work, or desire/feeling to kill or harm someone, or support for traumatic events or grief and loss)”. This agent is now capable of understanding its specific task of execution and will use it to declare itself as the expert for such a topic. As a result, all the user inquiries related to mental wellness will be forwarded to this expert.

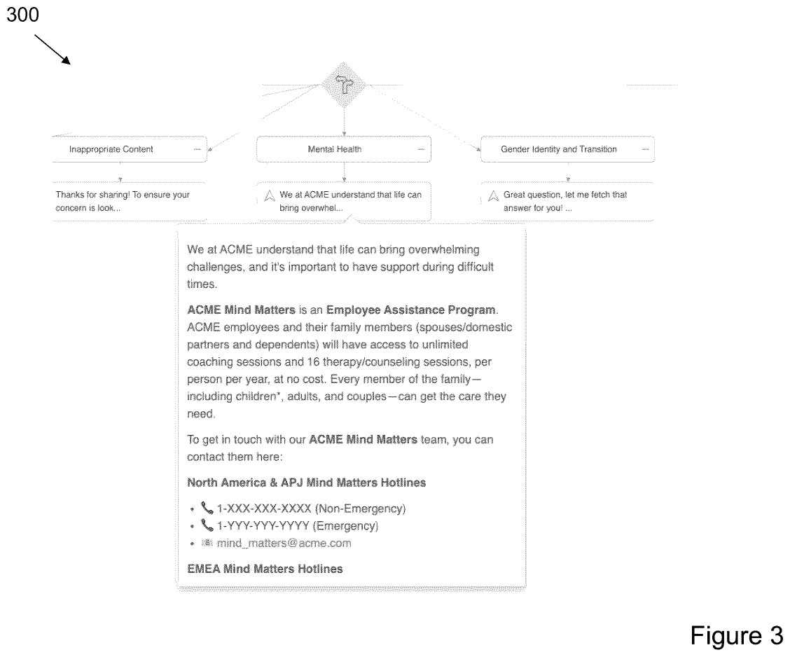

As seen with respect to chart 300 in FIG. 3, the associate flow template for select branches of a Prescriptive Conversational Agent. Each branch is a different agent specialized in providing prescriptive answers for specific topics of expertise, like sign language interpreter, sobriety and alcoholism, inappropriate language, etc.). Notice that this multi-agent flow aggregation is an optimized view of multiple agent flows grouped together within the same flow, and using a decision node based on the different agent scopes to forward the information to the right agent. More simply, each agent can also have its own dedicated flow (single-branch single-flow).

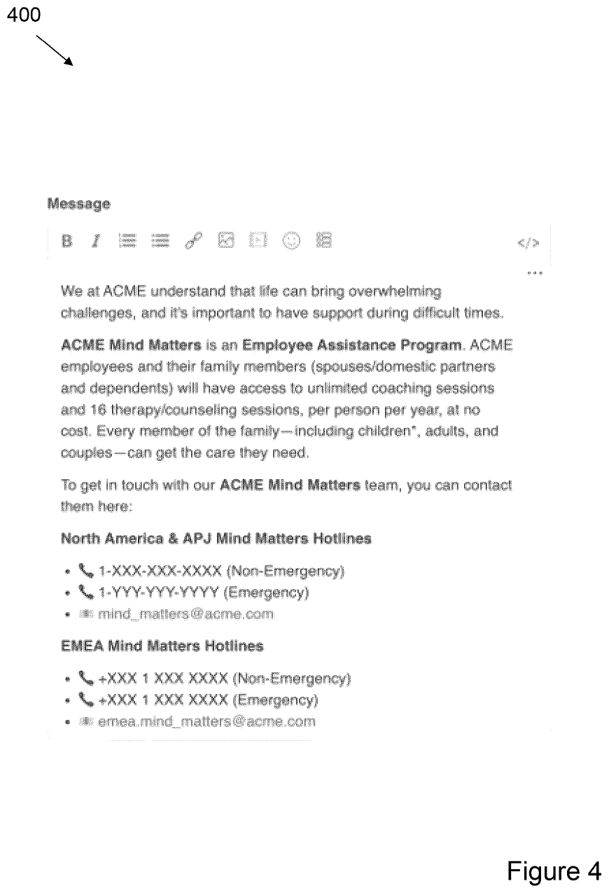

Message 400 in FIG. 4 is an example of a prescriptive answer entered by the user for the Mental Wellness agent. The user can manually enter the prescriptive answer that the mental wellness agent needs to provide in response to mental wellness user inquiries. Notice how the answer provided by the user in FIG. 4 is automatically absorbed in the flow. Notice that these answers are prescriptive and will not be modified by the agent. These agents are very important for highly regulated domains and industries like legal, HR, or the pharmaceutical industry.

As seen with respect to chart 500 in Figure, a Prescriptive Action Agent also has a distinct scope, workflow, and output. For example, an example of agent scope for prescriptive action agents which is capable to pull real-time information of company stocks is “The scope of this agent is to provide the real-time value of stock values, either referred to as the user company stock (like Cisco stock), or as the company ticker symbol (like CSCO).” The user can select the action workflow from a list of available action workflows or can enter the required information to define and test the integration needed. The available does have already pre-built integrations and authentications with third-party system. Conversely, the user might enter the info required here to create a new integration. For example, for this agent, either the selected workflow or the user will need information about the name of the Integration to use “Twelve Data Stock API”, the OAUTH authentication token and the associate API URL to be called with the required input parameters to be passed like: https://api.twelvedata.com/quote?symbol=${stockSymbol}.

Another example relates to a Q&A Retrieval Agent (Private KB) where scope for a Q&A Retrieval agent for Private KB is “You are a Q&A expert asked to provide a precise answer to user requests using solely content from the documents provided as an input. If no answer can be found, do X. Else, generate your answer” This agent will have a flow which is already integrated with RAG services, which takes care of the indexing, chunking, chunk relevancy checking and answer generation. As a result, the user needs to simply define the set of private knowledge articles that the RAG service is asked to operate, which can either be a single knowledge article, or a set of many knowledge articles organized into a data source. The user can provide some explicit directions on how the final answer shall look like. For example, the user can specify the answer not to exceed 300 words at maximum (brevity of answers) and use an HTML format with only bolding and italics.

Another example relates to Q&A Retrieval Agent (Public KB) where scope can be “You are a Q&A expert asked to provide a precise answer to user requests by solely using information from the provided public source(s) as an input. The user can provide the list of public source domains within which the public search service shall operate (these are called whitelisted public sources). An example of a whitelisted public source provided as an input is available from www.dol.gov.

Another example relates to a Dynamic Multi-tasks Action Agent where scope is that of an SAP PR & PO Expert agent with expertise in purchase requisition management, and can be defined as “You are a SAP assistant support agent, who is an expert in the following multiple tasks executed on the SAP System: View status of purchase requisitions (PRs) and orders (POs), View details of purchase requisitions (PRs) and orders (POs), Retrieve supplier invoices and contact information, etc.” In this example, a workflow does not need to be associated but can instead be automatically generated based on the user inquiries. This is because this agent can address multiple tasks on the same system and having a pre-canned workflow will not scale as needed.

Another example relates to Personal Assistant Agents, where scope for an agent with expertise in drafting job requisitions is “Act like an ACME HR Recruiter with deep expertise in creating comprehensive job requisitions for ACME corporation. You need to draft a job description and you need some key information to be provided by the user in order for you to draft an effective job requisition. The key information is: 1. Job Title (Clear and concise title that reflects the role), 2. Department (Specify which department the role belongs to), 3. Type of Position/Location (like full-time of part-time, whether onsite (provide location), remote or hybrid ) 4. Job summary (brief overview of the role), 5. Key responsibilities (Bullet points that detail the main duties of the position). This should be action-oriented and specific, 6. Required Qualifications (Essential skills, education, certifications, and years of experience needed for the role), 7. Preferred Qualifications (Additional skills or experience that would be an advantage but are not mandatory), 8. Compensation and Benefits (Include salary range (if possible) and outline key benefits like health insurance, paid time off, etc.).

In one embodiment with an Agent Editor (Loop), the user can add special logic to have the agent itself to assess whether its task can be considered as completed or not. For example, a user which requires to have all key information entered before providing a job req draft, will enter the following logic: “Assess whether the user request contains this information and if some information is missing, ask the user to provide the missing information. If the user has provided you with all the information needed, then your answer is null. Otherwise, compile a brief answer to the user asking for the missing information, using a formal and engaging communication style. Your response should be at most 350 words. Format your response in HTML format, with emojis, bolding and italics. Return your response. Save your response in tempResponse.”. When Agent Editor is enabled, a workflow is automatically generated in support of the agent to ensure that the whole history of previous draft versions and back-and-forth with the user is actually used when redrafting the answer. The flow can automatically introduce the exit condition of the user being satisfied or not with the provided answer which guarantees that multiple iterations with the users can be supported. If Agent Editor is disabled, the agent will complete its task (agent scope) based only on the first information provided by the user (no interaction with the users but more of a zero-shot task execution).

In some embodiments, to safeguard sensitive operations and ensure data integrity, agents incorporate strong security measures. These can include an Authentication & Authorization where agents operate with token-based security standards like OAuth 2.0, OpenID Connect, or Single Sign-On (SSO) for secure user and service access. Role-based access control (RBAC) governs user permissions, ensuring that only authorized entities can trigger workflows or access data. Communications between agents, users, and external services can be encrypted using TLS/SSL protocols for data in transit. At-rest data (such as logs or session data) is encrypted with robust encryption standards like AES-256 to prevent unauthorized access. Agents can track all interactions, including queries, system events, and task executions, into tamper-proof audit logs. Monitoring tools capture key metrics and alerts for abnormal activities, ensuring quick detection of suspicious behaviors. Each agent can be set to adhere to data privacy regulations like GDPR or CCPA. Agents ensure that sensitive user data is anonymized and processed according to compliance policies, with explicit user consent where necessary. In some embodiments, secure session management can be maintained so that user-agent interactions are tracked via secure tokens, and sessions automatically expire after a set period to mitigate session hijacking risks.

In some embodiments, agents need robust interfaces to communicate with other systems and exchange data effectively. Agents can expose well-defined RESTful APIs or GraphQL endpoints that allow external systems (such as UI dashboards, backend services, or other agents) to query, trigger, or configure agent tasks. These APIs provide flexible mechanisms for issuing commands, retrieving results, or receiving events. In some embodiments agents are integrated with a service bus (e.g., Kafka, RabbitMQ, or AWS SQS) for asynchronous communication using an event driven architecture. This enables agents to publish and subscribe to events, enabling real-time event-driven workflows. Agents can push task updates to Kafka topics, or listen for new tasks triggered by external events, ensuring they operate efficiently in a loosely coupled environment. In some embodiments, agents coordinate with orchestration layers (such as Kubernetes, AWS Step Functions, or Apache Airflow) to manage distributed workflows. These orchestrators send tasks to agents, aggregate their results, and handle agent lifecycle management (e.g., scaling agents up or down based on demand). Agents can also interact with other software modules across the enterprise via lightweight APIs, allowing them to fetch data (e.g., HR data from Workday, customer data from Salesforce) or execute actions (e.g., reset passwords or generate reports) or specific services like search & rag services, and alike. These integrations enable agents to perform complex, multi-step tasks by delegating specific responsibilities to external systems.

As used herein, ‘data’ and ‘information’ can be used interchangeably (e.g., ‘data processing’ and ‘information processing’). In some embodiments, the term ‘datum’ (plural ‘data’) can signify a representation of the value or the answer to a question (e.g., “yes” or “no”), while the term ‘information’ can signify a set of data with structure (often signified by ‘data structure’). A data structure is used in commerce to transform an electronic device for use as a specific machine as an article of manufacture. Data and information are physical objects, for example binary data (a ‘bit’, usually signified with ‘0’ and ‘1’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills and styles are authored, structured, and enabled—objectively—as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit—such components include resistors, memristors, capacitors, magnetic inductors, crystals, Josephson junctions, transducers, sensors, antennas, waveguides, etc. Active electronic components require a source of energy and can inject energy into a circuit—such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures—such components include switches, relays, protection devices (e.g., fuses, circuit breakers), heat sinks, fans, cables, wires, terminals, connectors and printed circuit boards.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language, also can be transformed into a specification for a structure of electronic components that transform data and information that produce the same result as the process.

A module can be permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘I/O’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, quantum operations, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language.

As used herein, the term ‘program’ (also referred to as an ‘application program’) signifies one or more processes and data structures that structure a module, processor or computer to be used as a specific machine. One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program and is typically not very accessible to or modifiable by the user of a computer. Computer programs and firmware are often specified using source code written in a programming language, such as C. Modules, circuits, processors, programs and computers can be specified at multiple levels of abstraction and have value as products in commerce as taxable goods.

A program can be transferred into one or more memories of the computer or computer system from a data and information device or storage system. A computer system typically has a device for reading storage media that is used to transfer the program, and/or has an interface device that receives the program over a network.

As will be understood, a computer system 300 such as illustrated with respect to FIG. 3 is suitable for supporting embodiments described in this disclosure and can include at least one computer which communicates with peripheral devices via bus subsystem. Typically, as depicted in FIG. 8, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem, comprising a memory subsystem and a file storage subsystem, user interface input devices, user interface output devices, and/or a network interface subsystem. The input and output devices enable direct and remote user interaction with the computer system. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor. In some embodiments, the computer system can send data or distribute processes to a computer cloud or other available collections of computing systems.

A computer system typically is structured, in part, with at least one operating system program. The computer system typically includes a Basic Input/Output System (BIOS) and processor firmware. The operating system, BIOS and firmware are used by the processor to structure and control any subsystems and interfaces connected to the processor.

Any embodiment is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes.

Network interface subsystem provides an interface to outside networks, including an interface to a communication network, and is coupled via communication network to corresponding interface devices in other computer systems or machines. Communication networks can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 18 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into a computer system or onto a communication network. User interface input devices typically enable a user to select objects, icons, text and the like that appear on some types of user interface output devices, for example, a display subsystem.

User interface output devices can include a display subsystem, a printer, a fax machine, or a non-visual communication device such as audio and haptic devices. The display subsystem can include a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of a computer system to the user or to another machine or computer system. Such devices are connected by wire or wirelessly to a computer system.

The memory subsystem typically includes a number of memories including a main random-access memory (‘RAM’) (or other volatile storage device) for storage of instructions and data during program execution and a read only memory (‘ROM’) in which fixed instructions are stored. File storage subsystem provides persistent storage for program and data files, and can include a solid state memory module, a magnetic hard disk, an optical drive, a flash memory such as a USB drive, or removable media cartridges. If the computer system includes an input device that performs optical character recognition, then text and symbols printed on a physical object (such as paper) can be used as a device for storage of program and data files. The databases and modules used by some embodiments can be stored by file storage subsystems.

The bus subsystem provides a device for transmitting data and information between the various components and subsystems of the computer system. Although the bus subsystem is depicted as a single bus, alternative embodiments of the bus subsystem can use multiple buses. For example, a main memory using RAM can communicate directly with file storage systems using Direct Memory Access (‘DMA’) systems.

The memory can include a non-transitory, processor readable data and information storage medium associated with file storage subsystem, and/or with network interface subsystem, and can include a data structure specifying a circuit design. The memory can be a solid state memory module, a magnetic hard disk, an optical medium, a removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light.

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims herein. When an embodiment comprises a particular feature, structure, function or characteristic, it is within the knowledge and understanding of a skilled person to use such feature, structure, function, or characteristic in connection with another embodiment whether or not explicitly described, for example, as a substitute for another feature, structure, function or characteristic.

In view of the Detailed Description, a skilled person will understand that many variations of any embodiment can be enabled, such as function and structure of elements, described herein while being as useful as the embodiment. One or more elements of an embodiment can be substituted for one or more elements in another embodiment, as will be understood by a skilled person. Writings about any embodiment signify its use in commerce, thereby enabling other skilled people to similarly use this embodiment in commerce.

This Detailed Description is written to provide knowledge and understanding. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

Additionally, This Detailed Description is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified or incorporated with respect to any one embodiment also can be included with any other embodiment. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any embodiment can have more structure and features than are explicitly specified in the Claims.

1. A method of selecting and interacting with agent types for an agentic AI system, comprising:
deploying an agent based on a template, with the agent assigned to a functional domain required by an enterprise, wherein the agent is selected to be one of
a Prescriptive Conversational Agent;
a Prescriptive Action Agent;
a Q&A Retrieval Agent for private knowledge bases;
a Q&A Retrieval Agent for public knowledge bases;
a Dynamic Multi-task Action Agent;
a Personal Assistant Agent; and
connecting the agent to a reasoning engine and orchestration module able to send and receive requests to the agent.

2. The method of selecting and interacting with agent types for an agentic AI system of claim 1, wherein the agent further comprises an external agent.

3. The method of selecting and interacting with agent types for an agentic AI system of claim 1, wherein the functional domain further comprises at least one of IT, HR, Finance, Engineering, and Sales and Marketing.

4. The method of selecting and interacting with agent types for an agentic AI system of claim 1, wherein the agent has an associated name and avatar.

5. The method of selecting and interacting with agent types for an agentic AI system of claim 1, wherein the agent has an associated persona.

6. The method of selecting and interacting with agent types for an agentic AI system of claim 1, wherein the template associated with the agent has a set of inputs, integrations, external services, channels, and business logic.

7. The method of selecting and interacting with agent types for an agentic AI system of claim 1, wherein the agent has an associated agent scope.

8. The method of selecting and interacting with agent types for an agentic AI system of claim 1, wherein the agent has an associated agent output.

9. The method of selecting and interacting with agent types for an agentic AI system of claim 1, wherein functional domains further comprise at least one of IT, HR, Finance, Engineering, and Sales and Marketing.

10. An agentic AI system architecture able to respond to a user request, comprising:
multiple agents, each agent being assigned to a functional domain required by an enterprise wherein each of the multiple agents is selected to be one of
a Prescriptive Conversational Agent;
a Prescriptive Action Agent;
a Q&A Retrieval Agent for private knowledge bases;
a Q&A Retrieval Agent for public knowledge bases;
a Dynamic Multi-task Action Agent;
a Personal Assistant Agent;
a reasoning engine supported by at least one large language model (LLM), with the reasoning engine being able to interpret a user request and decompose the user request into one or more mini-tasks; and
an orchestrator module connected to the reasoning engine and able to route those mini-tasks based on the user request to at least one of the multiple agents for further processing; and wherein
the orchestrator module and reasoning engine can collect and reconcile processed results from the multiple agents and prepare a response to the user request.

11. The agentic AI system architecture of claim 10, wherein multiple LLMs are used to assist in domain specific interpretation of the user request.

12. The agentic AI system architecture of claim 10, wherein the reasoning engine can engage the user for clarification in response to the user request.

13. The agentic AI system architecture of claim 10, wherein the reasoning engine supports reinforcement learning.

14. The agentic AI system architecture of claim 10, wherein the multiple agents further comprise at least some external agents.

15. The agentic AI system architecture of claim 10, wherein functional domains further comprise at least one of IT, HR, Finance, Engineering, and Sales and Marketing.

16. The agentic AI system architecture of claim 10, wherein the user request is submitted through an engagement channel to the agentic AI System.

17. A method of building agents for an agentic AI system, comprising the steps of:
having a user select an agent template that incorporates a guided set of input, integrations, external services, channels, and business logic;
customizing the agent template to serve specific user needs;
deploying the agent based on a template, with the agent assigned to a functional domain required by an enterprise; and
connecting the agent to a reasoning engine and orchestration module able to send and receive requests to the agent.

18. The method of building agents for an agentic AI system of claim 17, wherein the agent is selected to be one of
a Prescriptive Conversational Agent;
a Prescriptive Action Agent;
a Q&A Retrieval Agent for private knowledge bases;
a Q&A Retrieval Agent for public knowledge bases;
a Dynamic Multi-task Action Agent; and
a Personal Assistant Agent.

19. The method of building agents for an agentic AI system of claim 17, wherein the agent selected is a Prescriptive Conversational Agent; and wherein the agent template allows for interactions with multi-agent flow aggregation using multiple branches, each branch having a different agent specialized in providing prescriptive answers for specific topics of expertise.

20. The method of building agents for an agentic AI system of claim 17, wherein the agent selected is a Prescriptive Action Agent; and wherein the agent template allows a user to select the action workflow from a list of available action workflows or enter the required information to define and test needed integration.

21. The method of building agents for an agentic AI system of claim 17, wherein the agent selected is a Q&A Retrieval Agent for private knowledge bases; and wherein the agent template allows a user to define the set of private knowledge articles that a Retrieval Agent can operate, wherein a single knowledge article, or a set of many knowledge articles organized into a data source can be used.

22. The method of building agents for an agentic AI system of claim 17, wherein the agent selected is Q&A Retrieval Agent for public knowledge bases; and wherein the agent template allows a user to provide the list of public source domains within which the public search service can operate.

23. The method of building agents for an agentic AI system of claim 17, wherein the agent selected is a Dynamic Multi-task Action Agent; and wherein the agent template does not require a workflow to be associated and causes the workflow to be automatically generated based on user inquiries.

24. The method of building agents for an agentic AI system of claim 17, wherein the agent selected is a Personal Assistant Agent; and wherein the agent template also supports an Agent Editor (Loop), that the user can add special logic to have the agent itself to assess whether its task can be considered as completed.
